(19) United States
(12) Patent Application Publication
(10) Pub. No.: US 2010/0114364 A1
(43) Pub. Date: May 6, 2010

(54) METHOD AND SYSTEM TO RUN MULTIPLE SORT SCHEMES WITHOUT INTERRUPTING SORTING OPERATIONS

(76) Inventors: Wilfried HAHN, Muhltal (DE); Roland Schmidt, Echzell (DE); Jens Lischke, Budingen (DE)

Correspondence Address: MCDERMOTT WILL & EMERY LLP, 600 13TH STREET, N.W., WASHINGTON, DC, 20005-3096, US

(21) Appl. No.: 12/608,603

(22) Filed: Oct. 29, 2009

Related U.S. Application Data
(60) Provisional application No. 61/109,257, filed on Oct. 29, 2008.

(30) Foreign Application Priority Data
Apr. 27, 2007 (DE) 10 2007 019 948

(51) Int. Cl. B07C 3/10; G06F 7/00

(52) U.S. Cl. 700/224; 209/509; 700/223

(57) ABSTRACT

The present teachings relate to techniques and equipment for mail item processing. More particularly, the present teachings provide for a method and system for the sorting of mixed mail items. Multiple sort schemes are loaded on a mixed mail sorter for different clients. A first sorting run, controlled with a first sort scheme, is conducted such that the mail items for a first client are transported to a first sub-set of mail sort bins. After the first sorting run is ended, a switchover is performed such that a second sorting run, which is carried out with another sort scheme, can be started, thereby reducing the changeover times between sorting runs.

### RELATED APPLICATIONS

This application claims the benefit of U.S. Provisional Application No. 61/109,257, filed Oct. 29, 2008, the disclosure of which is entirely incorporated herein by reference.

This application is related to German Patent Application No. 10 2007 019 948.3, filed by Wilfried Hahn et al., filed on Apr. 27, 2007, entitled “Mixed-Mail Sorter” and published on Oct. 30, 2008.

### TECHNICAL FIELD

The present subject matter relates to techniques and equipment for mail item processing, and particularly, a method and system for the sorting of mixed mail items.

### BACKGROUND

Sorting operations require identifying the destination address and hence delivery point for mail pieces then sorting these items to sort destinations such as bins or containers based on the sorting requirements established by a postal authority or other mail carrier. Customary sorting operations allocate all of the available sort destinations with a sort scheme which allocates groups of delivery points, defined by the postal authority, to sort destinations. When all the mail pieces associated with the sorting job have been run the operators must sweep all of the mail pieces from the machine before the next job is run to ensure that no mail pieces become mixed between jobs. On a larger machine this can take a considerable amount of time, in excess of 20 minutes. The sweeping activity at the end of the job lowers productivity of the sorting operations by a significant amount when you consider that the sorter can operate at 50,000 mail pieces per hour. This productivity loss can be reduced by better allocation of the sort destinations.

### SUMMARY

The teachings herein alleviate one or more of the above noted problems by providing a system and related method for controlling a mixed-mail sorter, wherein multiple sort schemes/algorithms are simultaneously loaded on the sorter for different clients. A first sorting run, controlled with a first sort scheme, is conducted such that the mail items for a first client are transported to a first set of sort bins. After the first sorting run is ended, a switchover is performed such that a second sorting run, which is carried out with another sort scheme, can be started. The emptying and the preparation can take place with the first sub-set of mail sort bins, while the second sorting run is already being carried out and mail items for the second sort run are sorted to a second sub-set of mail sort bins different from the first sub-set. Thus, the changeover times which occur between individual sorting runs can be advantageously shortened, and in turn, the overall efficiency of a sort operation is improved.

It is desirable to provide a method for sorting mixed mail items. The method includes loading a plurality of sort schemes onto a mixed mail sorter. Assigning a first sort scheme to a first mailing for a first client. The first mailing includes a plurality of mail items. A second sort scheme is assigned to a second mailing for a second client. The second mailing includes a plurality of mail items. A first sorting run is conducted on the mixed mail sorter for the first mailing utilizing the first sort scheme, such that the plurality of mail items of the first mailing are transported to a first sub-set of mail sort bins based on delivery point data and the first sort scheme. Upon completion of the first sorting run, a second sorting run is initiated for the second mailing utilizing the second sort scheme. The second mailing is transported to a second sub-set of mail sort bins based on delivery point data and the second sort scheme. The second sub-set of mail sort bins is different from the first sub-set. During the second sorting run, the sorted mail items of the first mailing are clearing from the first sub-set of sort bins.

It is further desirable to provide a system for sorting mixed mail items. The system includes a mixed mail sorter for sorting of mixed mail items. The mixed mail sorter includes a plurality of mail sort bins for receiving a plurality of sorted mail items. A control processer is provided and is associated with the mixed mail sorter. The control processor is loaded with a plurality of sort schemes for a plurality of mailings from a plurality of clients. The control processor is configured to control the mixed mail sorter such that a plurality of mail items for a first mailing from a first client are sorted to a first sub-set of the mail sort bins based on delivery point data and a first sort scheme. The control processor is configured to control the mixed mail sorter such that upon completion of the sorting of the first mailing, a plurality of mail items for a second mailing from a second client are sorted to a second sub-set of the mail sort bins based on delivery point data and the second sort scheme. The second sub-set of mail sort bins is different from the first sub-set.

The advantages and novel features are set forth in part in the description which follows, and in part will become apparent to those skilled in the art upon examination of the following and the accompanying drawings or may be learned by production or operation of the examples. The advantages of the present teachings may be realized and attained by practice or use of the methodologies, instrumentalities and combinations described herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 shows a letter mail sorter configuration.

FIG. 2 shows a complete line for sorting mixed mail.

FIG. 3 shows the diverter module of a mixed-mail sorter.

FIG. 4 is an exemplary process flow diagram.

FIG. 5 illustrates a network or host computer platform, as may typically be used to implement a server.

FIG. 6 depicts a computer with user interface elements.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Mail sorting operations are generally planned for a given period of operation, hence pre-planning of individual sorting jobs can be analyzed. Each job may require different sort schemes to meet postal authority requirements and production operations (first pass and subsequent pass sorting operations). Hence, the sort scheme allocation process can assign a group of sort destinations for the first sort scheme (job 1) and a different group of sort destinations to a second sort scheme (job x). The sort destination allocation process can be repeated for all the jobs planned for a given sorter or group of sorters. Since a different sort destination group is used on job 1 than will be used on a subsequent job, the subsequent job may be started immediately following the completion of the preceding job. The first group of sort destinations can be swept of mail pieces while the subsequent job is processed. The process of running jobs and concurrently sweeping mail pieces at the completion of a preceding job may continue for each new job.

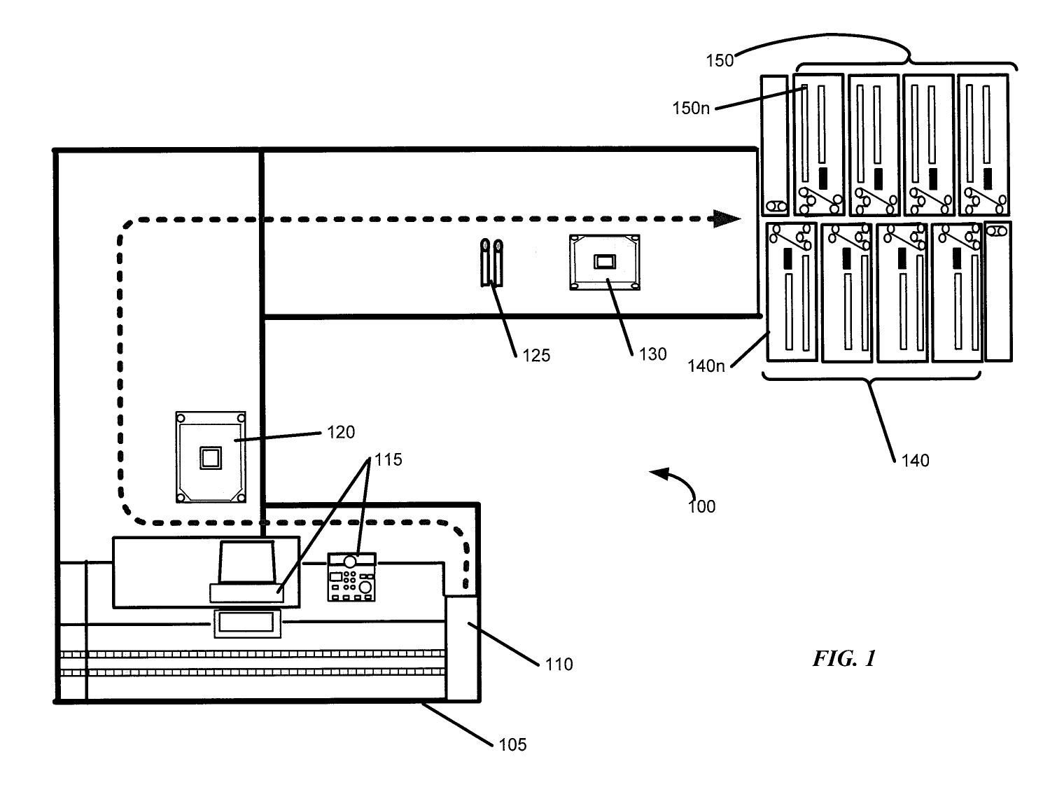

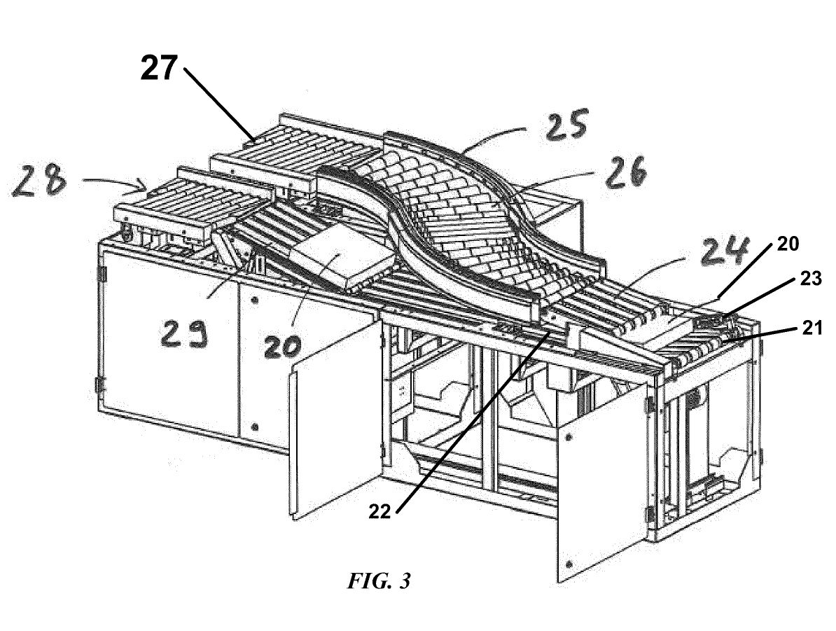

Sort destination allocation can take into account many different factors, such as but not limited to, mail makeup (expected distribution of delivery points), volume of mail expected in each group of delivery points, number of sort destinations available and machine configuration. Generally, the sort destination groups will be kept together in sequential groups to avoid sweeping errors. A possible grouping would be the right side (140 FIG. 1, 27 FIG. 3) for job 1 and left side (150 FIGS. 1 and 28 FIG. 3) for job 2.

Referring now to FIG. 1 for an exemplary letter mail sorter 100. Job data and sort scheme information is input by an operator or downloaded from a server to set up the sorter control processor 115. The mail pieces associated with a job are loaded onto the magazine 105 as mail is processed. Each mail piece is individually fed into the sorter by the feeder 110. The imaging system 120 will read the address delivery point data from each mailpiece which will be used to print 125 and verify 130 the delivery point barcode. The delivery point data and sort scheme are used to control which sort bin group 140, 150 and location 140n, 150n will receive the current mail piece.

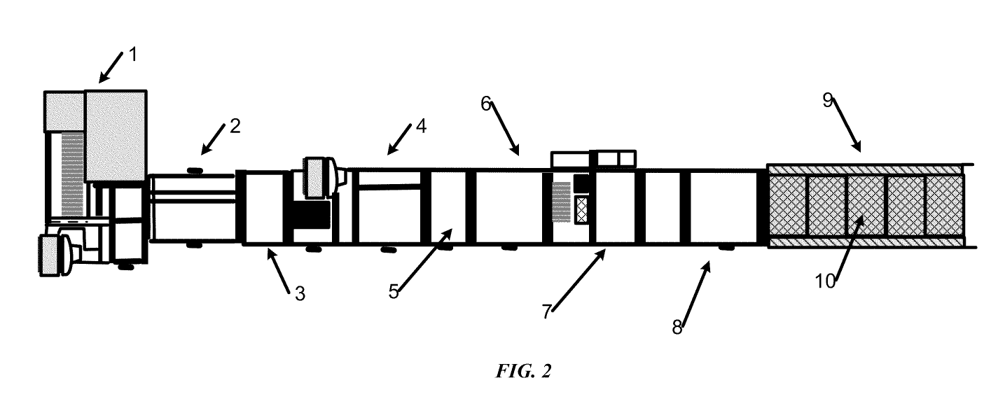

Turning now to FIG. 2, the sorting line for the continuous sorting of input mixed mail is of modular construction and has different modules with separate functionalities. In the module 1, the letter input means, the unsorted items of mail are deposited upright, separation having already taken place here. In a flipping unit 2, they are laid onto the conveying apparatus with the address pointing upwards, a handrest 3 also making it possible in this case to lay down the items of mail separately. In the camera section 4, the items of mail are recorded and measured for postage determination before they are weighed on the dynamic scales 5. At this point, all the data which are important for the item of mail are present in the data set which is assigned to it. Since the computer requires a certain amount of time for processing, a retardation module 6 is provided which gives an apparatus 7 for labeling, the possibility of providing the items of mail with readable labels. A corresponding module 8 is provided to check the print.

Behind the module 8, the single-track feed section ends and the actual sorting section begins with the sorting unit 9 which has six individual sorting modules here with sorting compartments 10 for receiving transport boxes. At the sorting modules, the conveying apparatus has trap doors which can be actuated separately, are configured as flaps and close discharging paths to the transport boxes. Control means are provided for actuating the said trap doors, which control means open the trap doors after a machine-readable item of distributor information which is attached to the items of mail has been read out.

FIG. 3 then shows a diverter module, as can be used for the second embodiment of the mixed-mail sorter according to the present teachings. The items of mail 20 pass from a single-track feed section (not shown) to the sorting section which begins with the diverter module.

The diverter module is adjoined (on the left in the illustration) by the sorting section having two conveyor belts 27 and 28 which are supplied by the diverter module. The guiding device which makes it possible to sort the items of mail into a second row of transport boxes which are positioned under conveyor belts 27 and 28, is realized as described below.

The items of mail 20 pass to a trap door which is configured as a flap 21 and leads onto a feeding point of the second conveyor belt 22 which lies under it. The flap 21 is actuated via a pneumatic cylinder 23, the actuation comprising lowering and raising. If the flap 21 were not lowered, the item of mail 20 would be conveyed onto an upper conveying section 24 and would pass onto a curve part 25 in the form of an S-curve which has driven rolls 26. The curve part 25 guides the first conveyor belt 27 out of the direction of the second conveyor belt 28, the second conveyor belt 28 remaining rectilinear in relation to the single-track feed section. Behind the feeding point in the conveying direction, the second conveyor belt has a conveying section 24 which is configured as a rising ramp 29 and raises the second conveyor belt 28 to the level of the plane of the first conveyor belt 27.

The conveying belts 28 and 27 feed a series of sorting compartments 10 for receiving transport boxes with one line on the left of the sorter and other on the right, respectively. In a first method of operation of the mixed-mail sorters according to the present teachings, first of all a sorting run is carried out which ends in transport boxes which are positioned in each case on one side of the single-track or double-track sorting path, with the result that the transport boxes of the other side remain empty. When the first sorting run is ended, a collective switchover to the transport boxes on the other side is carried out either by the diverter or via the guiding means, with the result that the second sorting run which is carried out with another sorting algorithm can be started immediately. Therefore, the emptying and the preparation can take place on one side during a run, while the next run is already being carried out on the other side. The time for changing over the machine is shortened by the time which is otherwise required for exchanging the transport boxes.

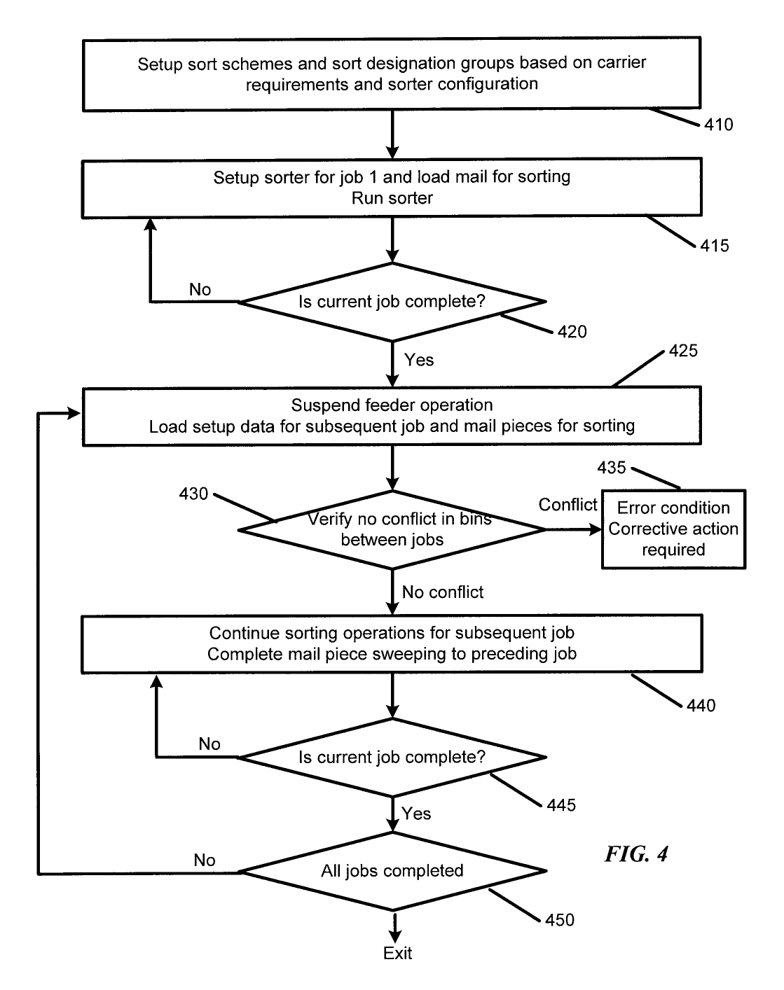

Referring now to FIG. 4 to follow an exemplary sorting operational flow. Step 410 includes all of the pre-production actions that are required before sorting operations. These steps include but are not limited to developing sort schemes, scheduling order of production jobs, allocating sort destinations to jobs and sort schemes, loading the data on server, downloading data from the server to sorter control systems and operator inputs to start a job. In Step 415, the first job is set up and the mail pieces are collected for this job. The magazine is loaded with the first batch of mail pieces. Sorter operations start by enabling the feeder. Mail pieces are loaded on the magazine for job 1 until all items are sorted, Step 420. In Step 425, feeder operations are suspended while the magazine is loaded with the mail pieces for the next job and the control data for the next job is entered. To be sure that no operator errors in setup have occurred, it is advisable to have the control system verify the no sort destinations from the previous job are being used by the current job Step 430. If there is re-use, mail pieces from the two jobs will be mixed and a serious error condition will occur, Step 435. If no conflict exists, sorting operations continues for the subsequent job while the final mail piece sweep is completed for the preceding job, Step 440. This continues until the current job is completed Step 445. If there are additional jobs to run, Step 450, operation returns to Step 425 for the next sorting job.

An example of sorting equipment for implementation in the present system and method is described in U.S. Pat. No. 7,498,539, issued on Mar. 3, 2009 to Ed Svyatsky et al., entitled “Progressive Modularity Assortment System with High and Low Capacity Bins”, which is entirely incorporated herein by reference. Another example of sorting equipment and sort scheme generation for implementation in the foregoing system and method is described in copending U.S. patent application Ser. No. 11/477,431 filed by Paul G. Kostyniuk et al., entitled “Sort Scheme Generation Based on Bin Capacity” and filed on Jun. 30, 2006, which is entirely incorporated herein by reference.

As shown by the above discussion, functions relating to mail sorting operations may be implemented on one or more computers operating as the sorter control processor 115 connected for data communication with the processing resources and any additional readers along the processing line as shown in FIG. 1. Although special purpose devices may be used, such devices also may be implemented using one or more hardware platforms intended to represent a general class of data processing device commonly used to run “server” programming so as to implement the functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the workflow templates for a number of production jobs as well as the various files for tracking data accumulated during one or more productions runs. The software code is executable by the general-purpose computer that functions as the sorter control processor 115 and/or the associated terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for mail sorting operations, in essentially the manner performed in the implementations discussed and illustrated herein.

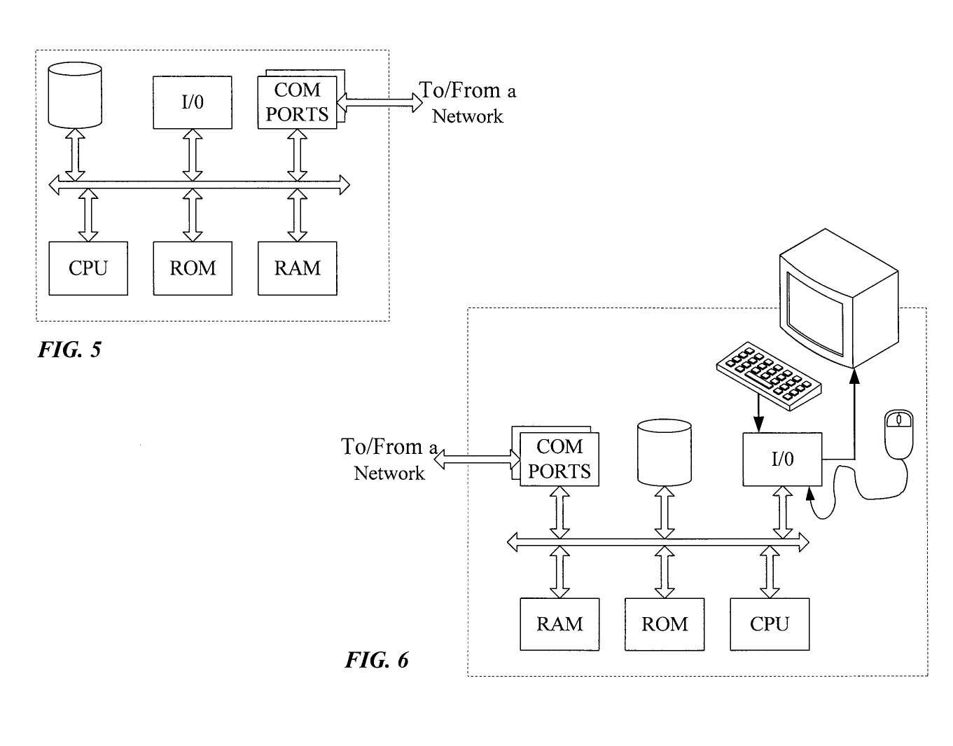

FIGS. 5 and 6 provide functional block diagram illustrations of general purpose computer hardware platforms. FIG. 5 illustrates a network or host computer platform, as may typically be used to implement a server. FIG. 6 depicts a computer with user interface elements, as may be used to implement a personal computer or other type of work station or terminal device, although the computer of FIG. 6 may also act as a server if appropriately programmed. It is believed that those skilled in the art are familiar with the structure, programming and general operation of such computer equipment and, as a result, the drawings should be self-explanatory.

For example, sorter control processor 115 may be a PC based implementation of a central control processing system like that of FIG. 6, or may be implemented on a platform configured as a central or host computer or server like that of FIG. 5. Such a system typically contains a central processing unit (CPU), memories and an interconnect bus. The CPU may contain a single microprocessor (e.g. a Pentium microprocessor), or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM or the like. The system memories also include one or more mass storage devices such as various disk drives, tape drives, etc.

In operation, the main memory stores at least portions of instructions for execution by the CPU and data for processing in accord with the executed instructions, for example, as uploaded from mass storage. The mass storage may include one or more magnetic disk or tape drives or optical disk drives, for storing data and instructions for use by CPU. For example, at least one mass storage system in the form of a disk drive or tape drive, stores the operating system and various application software as well as data, such as one or more sort scheme instructions. The mass storage within the computer system may also include one or more drives for various portable media, such as a floppy disk, a compact disc read only memory (CD-ROM), or an integrated circuit non-volatile memory adapter (i.e. PC-MCIA adapter) to input and output data and code to and from the computer system.

The system also includes one or more input/output interfaces for communications, shown by way of example as an interface for data communications with one or more other processing systems. Although not shown, one or more such interfaces may enable communications via a network, e.g., to enable sending and receiving instructions electronically. The physical communication links may be optical, wired, or wireless.

The computer system may further include appropriate input/output ports for interconnection with a display and a keyboard serving as the respective user interface for the processor/controller. For example, a printer control computer in a document factory may include a graphics subsystem to drive the output display. The output display, for example, may include a cathode ray tube (CRT) display, or a liquid crystal display (LCD) or other type of display device. The input control devices for such an implementation of the system would include the keyboard for inputting alphanumeric and other key information. The input control devices for the system may further include a cursor control device (not shown), such as a mouse, a touchpad, a trackball, stylus, or cursor direction keys. The links of the peripherals to the system may be wired connections or use wireless communications.

The computer system runs a variety of applications programs and stores data, enabling one or more interactions via the user interface provided, and/or over a network to implement the desired processing, in this case, including those for sorting operations, as discussed above.

The components contained in the computer system are those typically found in general purpose computer systems. Although summarized in the discussion above mainly as a PC type implementation, those skilled in the art will recognize that the class of applicable computer systems also encompasses systems used as host computers, servers, workstations, network terminals, and the like. In fact, these components are intended to represent a broad category of such computer components that are well known in the art. The present examples are not limited to any one network or computing infrastructure model—i.e., peer-to-peer, client server, distributed, etc.

Hence aspects of the techniques discussed herein encompass hardware and programmed equipment for controlling the sorting operations as well as software programming, for controlling the relevant functions. A software or program product, which may be referred to as a “program article of manufacture” may take the form of code or executable instructions for causing a computer or other programmable equipment to perform the relevant data processing steps regarding mail item sorting, where the code or instructions are carried by or otherwise embodied in a medium readable by a computer or other machine. Instructions or code for implementing such operations may be in the form of computer instruction in any form (e.g., source code, object code, interpreted code, etc.) stored in or carried by any readable medium.

Such a program article or product therefore takes the form of executable code and/or associated data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the relevant software from one computer or processor into another, for example, from a management server or host computer into the image processor and comparator. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the sorting control and attendant mail item tracking based on unique mail item identifier. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method for sorting mixed mail items, the method comprising steps of:
loading a plurality of sort schemes onto a mixed mail sorter;
assigning a first sort scheme to a first mailing for a first client, the first mailing comprising a plurality of mail items; and
assigning a second sort scheme to a second mailing for a second client, the second mailing comprising a plurality of mail items;
conducting a first sorting run on the mixed mail sorter for the first mailing utilizing the first sort scheme, such that the plurality of mail items of the first mailing are transported to a first sub-set of mail sort bins based on delivery point data and the first sort scheme;
upon completion of the first sorting run, initiating a second sorting run for the second mailing utilizing the second sort scheme, the second mailing transported to a second sub-set of mail sort bins based on delivery point data and the second sort scheme, the second sub-set of mail sort bins being different from the first sub-set; and
during the second sorting run, clearing the sorted mail items of the first mailing from the first sub-set of mail sort bins.

2. The method of claim 1, further comprising the step of:
upon completion of the first sorting run, suspending feeder operation such that setup data for the second mailing is loaded onto the mixed mail sorter.

3. The method of claim 2, further comprising the step of:
verifying that no sort destination conflict exists between the first and second sorting runs.

4. The method of claim 3, further comprising the step of:
upon verification of a conflict, initiating remedial action prior to initiating of second sorting run.

5. The method of claim 1, wherein the loading step comprises:
loading of the plurality of sort schemes onto a sorter control processor associated with the mixed mail sorter.

6. The method of claim 1, further comprising the step of:
upon clearance of the sorted mail items of the first mailing from the first sub-set of mail sort bins, conducting a third sorting run on the mixed mail sorter for a third mailing utilizing a third sort scheme, such that the plurality of mail items of the third mailing are transported to the mail bins not designated for the second mailing.

7. The method of claim 1, further comprising the steps:
scheduling an order of the first and second sorting runs; and
allocating sort destinations to the first and second sorting runs.

8. A computer system programmed to implement the method of claim 1.

9. A program product, comprising a physical machine-readable storage medium and executable code embodied in the medium, wherein execution of the code by at least one programmable computer causes the at least one programmable computer to perform the steps of the method of claim 1.

10. The method of claim 1, wherein
the first sub-set of mail sort bins comprises one or more mail sort bins; and
the second sub-set of mail sort bins comprises one or more mail sort bins.

11. A system for sorting mixed mail items, the system comprising:
a mixed mail sorter for sorting of mixed mail items, the mixed mail sorter including a plurality of mail sort bins for receiving a plurality of sorted mail items;
a control processer associated with the mixed mail sorter, the control processor loaded with a plurality of sort schemes for a plurality of mailings from a plurality of clients, the control processor configured to:
control the mixed mail sorter such that a plurality of mail items for a first mailing from a first client are sorted to a first sub-set of the mail sort bins based on delivery point data and a first sort scheme, and
control the mixed mail sorter such that upon completion of the sorting of the first mailing, a plurality of mail items for a second mailing from a second client are sorted to a second sub-set of the mail sort bins based on delivery point data and the second sort scheme, the second sub-set of mail sort bins being different from the first sub-set.

12. The system of claim 11 further comprising:
a magazine for loading the plurality of mail items of the first and second mailings.

13. The system of claim 11 further comprising:
a feeder for individually feeding each mail item individually from the magazine into the mixed mail sorter.

14. The system of claim 11 further comprising:
an image reader for reading address delivery point data from each mail item.

15. The system of claim 14, wherein the control processer utilizes delivery point data associated with each mail item, together with a particular sort scheme assigned to each mail item, to determine which mail sort bin will receive a particular mail item.

16. The system of claim 14 further comprising:
a printer for applying a delivery point barcode to one or more of the mail items.
